(19) United States
(12) Patent Application Publication
(10) Pub. No.: US 2020/0073356 A1
(43) Pub. Date: Mar. 5, 2020

(54) MOTOR PROGRAMMING DEVICE AND METHOD FOR INSTALLING AND MAINTAINING MOTOR USING THE SAME

(71) Applicant: Zhongshan Broad-Ocean Motor Co., Ltd., Zhongshan (CN)

(72) Inventors: Xiansheng ZHANG, Zhongshan (CN); Yong ZHAO, Zhongshan (CN); Meishuang CHEN, Zhongshan (CN)

(21) Appl. No.: 16/584,971

(22) Filed: Sep. 27, 2019

Related U.S. Application Data
(63) Continuation-in-part of application No. PCT/CN2018/103753, filed on Sep. 3, 2018.

(30) Foreign Application Priority Data
Mar. 26, 2018 (CN) 201810252624.0

(51) Int. Cl. G05B 19/10; G06K 7/14; G06F 3/0484; H04W 4/80

(52) U.S. Cl. CPC G05B 19/106; H04W 4/80; G06F 3/04847; G06K 7/1426

(57) ABSTRACT

A motor programming device includes a mobile phone and a Bluetooth communication device. The mobile phone includes a Bluetooth module, a motor information database, and an APP software module. The motor information database includes a plurality of records. The plurality of records each includes a motor model, user type, and corresponding operating parameters. The APP software module is configured to receive a piece of search information, automatically search in the motor information database a record corresponding to the search information, extract relevant data of the record, and program relevant data of the record to yield a program. The Bluetooth communication device is physically connected to a motor controller and wirelessly connected to the mobile phone via the Bluetooth module, and is configured to transmit the program produced by the APP software module to the motor controller.

### CROSS-REFERENCE TO RELATED APPLICATIONS

This application is a continuation-in-part of International Patent Application No. PCT/CN2018/103753 with an international filing date of Sep. 3, 2018, designating the United States, now pending, and further claims foreign priority benefits to Chinese Patent Application No. 201810252624.0 filed Mar. 26, 2018. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a motor programming device and to a method for installing and maintaining a motor using the same.

There are various types of digital motors manufactured by various manufacturers and having various control parameters. If a digital motor breaks down, a new motor replaces the old one. During replacement, the operating parameters for the new motor are written into the motor controller of the new motor in a process known as reprogramming. The reprogramming process requires a portable computer and technical knowledge.

### SUMMARY

The disclosure provides a motor programming device and a method of programming a motor controller of a motor using the device.

A motor programming device comprises a mobile phone and a Bluetooth communication device. The mobile phone comprises a Bluetooth module, a motor information database, and an APP software module. The motor information database comprises a plurality of records of a first motor; the plurality of records of the first motor each comprises a motor model, user type, and corresponding operating parameters. The APP software module is configured to receive a piece of search information, automatically search in the motor information database a record corresponding to the search information, extract relevant data of the record, and program relevant data of the record to yield a program. The Bluetooth communication device is configured to physically connect to a motor controller of a second motor and is wirelessly connected to the mobile phone via the Bluetooth module, and is configured to transmit the program produced by the APP software module to the motor controller of the second motor.

The plurality of records each comprises a quick response (QR) code field or barcode information of the first motor, and the APP software module comprises a scanning module; the scanning module is configured to scan a quick response (QR) code or barcode information of the first motor; and the search information corresponds to the QR code or barcode information of the first motor.

The search information comprises a motor model and a user type which are manually input.

The corresponding operating parameters comprise torque data, speed data and air volume data.

The torque data, the speed data, and the air volume data each comprise a plurality of data groups for different tap positions.

The Bluetooth communication device communicates with the motor controller via a universal asynchronous receiver/transmitter (UART).

A method of programming a motorusing the motor programming device, the method comprising:
1) scanning a quick response (QR) code or barcode information of a first motor using the scanning module of the APP software module of the mobile phone, and generating a piece of search information corresponding to the quick response (QR) code or barcode information of the first motor;
2) automatically searching in the motor information database a record corresponding to the search information, the record comprising a motor model, user type, and corresponding operating parameters;
3) extracting relevant data of the record, and programing relevant data of the record to yield a program; and
4) transmitting, by the Bluetooth communication device, the program produced by the APP software module to a motor controller of a second motor.

The method Comprises:
physically connecting the Bluetooth communication device to the motor controller of the second motor;
clicking the APP software module of the mobile phone;
scanning the quick response OR) code or barcode information of the first motor using the scanning module of the APP software module, so that the record of the first motor comprising the motor model, user type, and corresponding operating parameters is presented on an operation interface of the mobile phone;
clicking a Bluetooth icon on the operation interface, seeking the Bluetooth communication device, and wirelessly connecting the mobile phone and the Bluetooth communication device;
displaying, by the APP software module of the mobile phone, a successful connection between the mobile phone and the Bluetooth communication device; and
programing the record of the first motor comprising the motor model, user type, and corresponding operating parameters presented on the operation interface of the mobile phone to yield the program, and transmitting the program to the motor controller of the second motor.

Advantages of the motor programming device according to embodiments of the disclosure are summarized as follows. The motor programming device of the disclosure comprises a mobile phone and a Bluetooth communication device which are wirelessly connected, program and transmit the relevant data of the motor controller of a first motor to the motor controller of a second motor, and no extra equipment is involved. The programming device is compact and easy to carry. The programming method is easy to operate, and is efficient in loading the operating parameters of an old or broken motor controller to a new one.

### BRIEF DESCRIPTION OF THE DRAWINGS

FIG. 1 is a perspective view of a digital motor in the related art;

FIG. 2 is a perspective view of a motor controller of a digital motor in the related art;

FIG. 3 is a cross-sectional view of a digital motor in the related art;

FIG. 4 is a circuit block diagram of a motor controller of a digital motor in the related art;

FIG. 5 is a structural diagram of a motor programming device in Example 1 of the disclosure;

FIG. 6 is an icon of an APP software module installed on a mobile phone in Example 2 of the disclosure;

FIG. 7 is an interface of an APP software module of a mobile phone in Example 2 of the disclosure;

FIG. 8 is a diagram of a nameplate on a motor in Example 2 of the disclosure;

FIG. 9 is an interface showing the data obtained after scanning a QR code of a motor in Example 2 of the disclosure;

FIG. 10 is an interface showing a Bluetooth communication device has beer detected in Example 2 of the disclosure;

FIG. 11 is an interface showing a Bluetooth communication device is successfully connected in Example 2 of the disclosure; and

FIG. 12 is a programming interface in Example 2 of the disclosure.

### DETAILED DESCRIPTION

To further illustrate, embodiments detailing a motor programming device and a programing method using the same are described below. It should be noted that the following embodiments are intended to describe and not to limit the disclosure.

### EXAMPLE 1

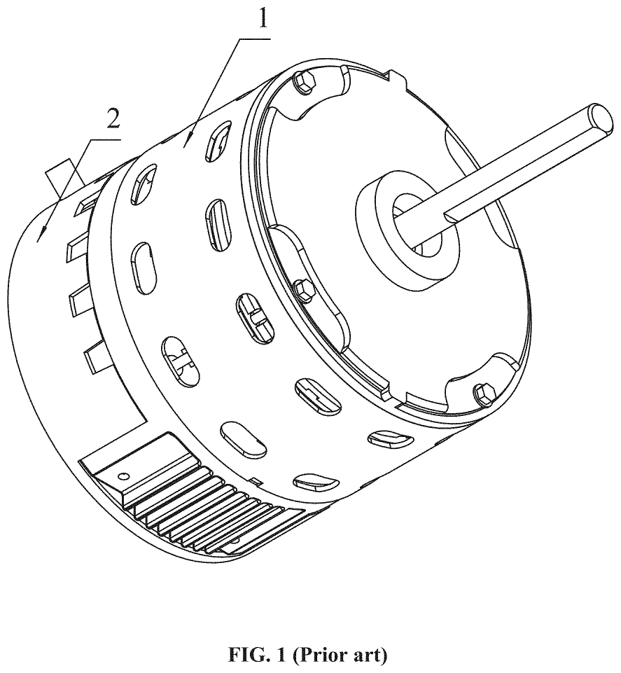

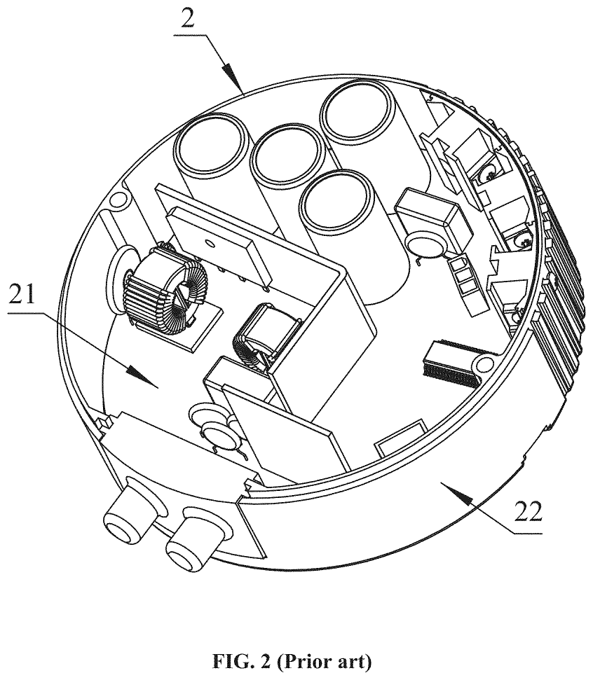

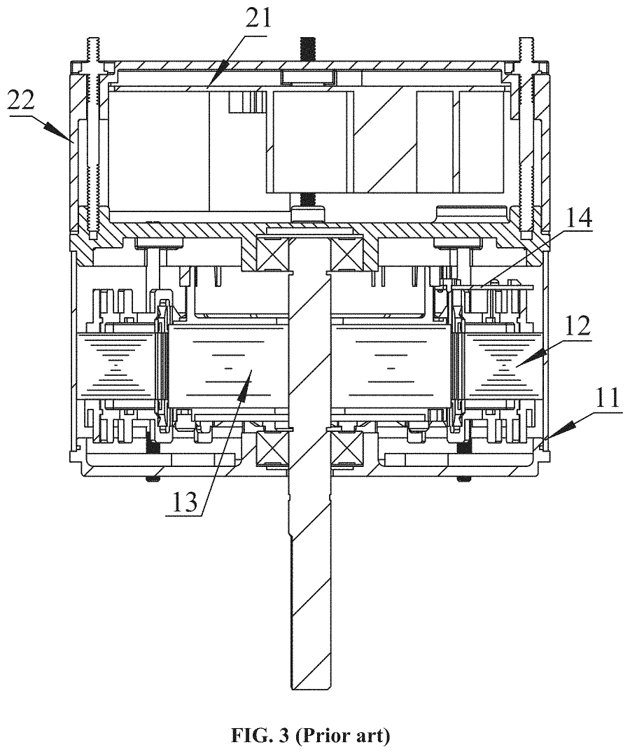

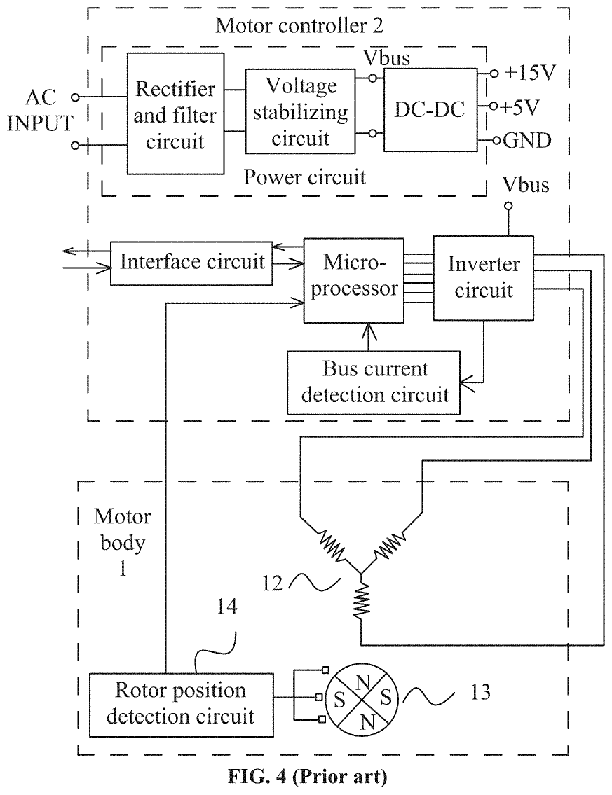

As shown in FIGS. 1-4, a conventional digital motor comprises a motor controller 2 and a motor unit 1. The motor unit 1 comprises a stator assembly 12, a rotor assembly 13, and a housing assembly 11. The stator assembly 12 is mounted on the housing assembly 11. The motor unit 1 is mounted with a Hall sensor 14 detecting the rotor position. The rotor assembly 13 is disposed inside or outside the stator assembly 12. The motor controller 2 comprises a control box 22 and a control circuit board 21 mounted in the control box 22. The control circuit board 21 comprises a power supply circuit, a microprocessor, a bus current measurement circuit, an inverter circuit, and a rotor position measurement circuit 14 (i.e., a Hall sensor). The power circuit supplies each part of the circuit with power. The rotor position measurement circuit detects the rotor position signal and then inputs it to the microprocessor. The external device communicates with the microprocessor through the interface circuit. The microprocessor controls the inverter circuit, and the microprocessor controls the inverter that controls on and off of the coil windings which at each phase of the stator assembly 12. The microprocessor of the motor controller is a single-chip microcomputer with digital processing capability, that is, a digital motor (DM).

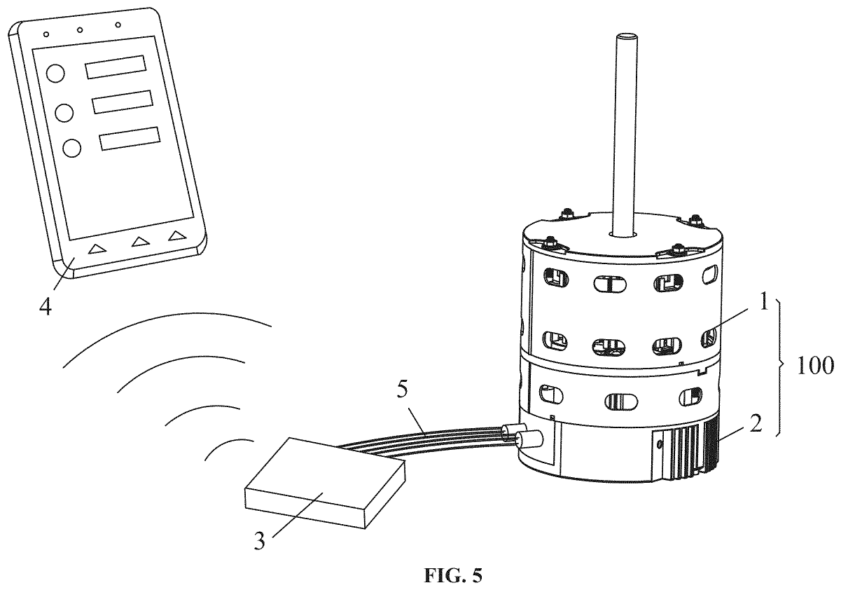

As shown in FIG. 5, a motor programming device for programming a digital motor 100 comprises a mobile phone 4 and a Bluetooth communication device 3. The Bluetooth communication device 3 is physically connected to the motor controller 2, and wirelessly connected with the mobile phone 4 to establish a Bluetooth communication mode. The mobile phone comprises a Bluetooth module and a motor information database comprising a plurality of records. Each record comprises a motor model, user type, and corresponding operating parameters. The APP software module is configured to receive a piece of search information, automatically searched in the motor information database a record corresponding to the search information, extracted relevant data of the record, and programed relevant data of the record to yield a program. The Bluetooth communication device is physically connected to a motor controller and wirelessly connected to the mobile phone via the Bluetooth module, and is configured to transmit the program produced by the APP software module to the motor controller.

As shown in FIG. 5, the digital motor 100 comprises a motor controller 2 and a motor unit 1. The Bluetooth communication device 3 is connected to the interface circuit of the motor controller 2 through the wires 5. The Bluetooth communication device 3 is in serial communication with the microprocessor of motor controller 2 through the interface circuit, and the Bluetooth communication device communicates with the motor controller through UART wired communication to transmit data.

Each record of motor information database comprises a QR code field or barcode information, and the APP software module comprises a scanning module; the scanning module is configured to scan a quick response (QR) code or barcode information of a first motor; and the search information corresponded to the QR code or barcode information of the first motor. The APP software module is then configured to receive a piece of search information, automatically search in the motor information database a record corresponding to the search information, extract relevant data of the record, and program relevant data of the record to yield a program. The Bluetooth communication device transmits the program to the motor controller.

TABLE 1
Motor information database comprising QR code, motor model, user type,
and torque data corresponding to five tap positions

| | | | M1 tap | M2 tap | M3 tap | M4 tap | M5 tap |
|---|---|---|---|---|---|---|---|
| | Motor | | position | position | position | position | position |
| QR code | model | User type | (torque) | (torque) | (torque) | (torque) | (torque) |
| AACC | ZYY001 | Dajin | 24.6 | 26.5 | 27.8 | 29.8 | 31.0 |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | . . . | . . . |
| EMCC | DYC002 | Aosi | 34.2 | 36.8 | 40.0 | 45.2 | 48.8 |

TABLE 2
Motor information database comprising barcode, motor model, user type,
and speed data corresponding to five tap positions

| | | | M1 tap | M2 tap | M3 tap | M4 tap | M5 tap |
|---|---|---|---|---|---|---|---|
| | | User | position | position | position | position | position |
| Barcode | Motor model | type | (speed) | (speed) | (speed) | (speed) | (speed) |
| 1234567 | DAY001 | MEIn | 500 rpm | 650 rpm | 800 rpm | 950 rpm | 1100 rpm |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | . . . | . . . |
| 8776544 | DAYC002 | CCo | 850 rpm | 1000 rpm | 1200 rpm | 1350 rpm | 1600 rpm |

TABLE 3
Motor information database comprising barcode, motor model, user type
and air volume data corresponding to five tap positions

| | | | M1 tap | M2 tap | M3 tap | M4 tap | M5 tap |
|---|---|---|---|---|---|---|---|
| | | | position | position | position | position | position |
| | Motor | | (air | (air | (air | (air | (air |
| Barcode | model | User type | volume) | volume) | volume) | volume) | volume) |
| 4434568 | DAYTT1 | MEX | 60 | 80 | 94 | 108 | 120 |
| . . . | . . . | . . . | . . . | . . . | . . . | . . . | . . . |
| . . . | . . . | . . . | . . . | . . . | . . . | . . . | . . . |
| . . . | . . . | . . . | . . . | . . . | . . . | . . . | . . . |
| 9933544 | DAYTTC2 | CCX | 140 | 160 | 180 | 200 | 225 |

As shown in FIG. 5, a method of programming a motor using the motor programming device described in Example 1 comprises: 1) scanning a quick response (QR) code or barcode information of a first motor using the scanning module of the APP software module of the mobile phone, and generating a piece of search information corresponding to the quick response (QR) code or barcode information of the first motor; 2) automatically searching in the motor information database a record corresponding to the search information, the record comprising a motor model, user type, and corresponding operating parameters; 3) extracting relevant data of the record, and programing relevant data of the record to yield a program; and 4) transmitting, by the Bluetooth communication device, the program produced by the APP software module to a motor controller of a second motor.

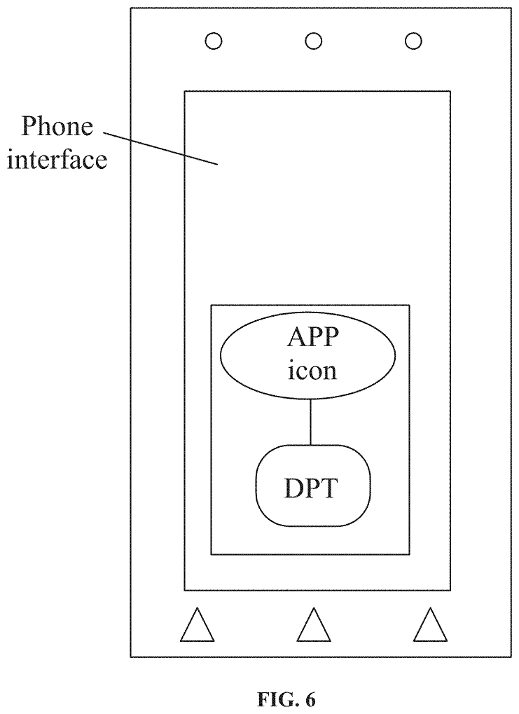

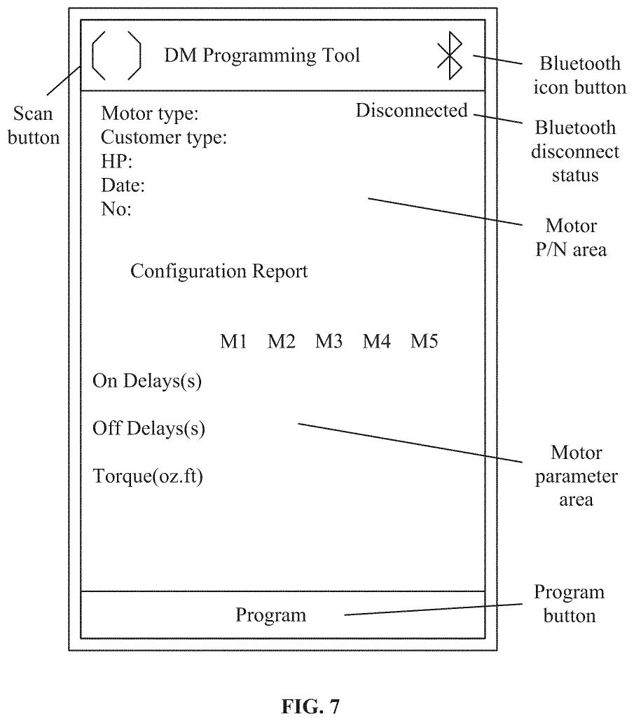

The operations of a maintenance worker are as follows: downloading a motor APP software module from a URL, installing the APP software module on a mobile phone, the corresponding APP icon is displayed on the mobile screen, as shown in FIG. 6; and clicking the APP icon on the phone screen to open the APP software module, as shown in FIG. 7.

The programming process are summarized as follows:

1) connecting physically a Bluetooth communication device to the motor controller of a new motor, as shown in FIG. 5;

2) clicking the icon of the APP software module on the screen of mobile phone to display the operation interface;

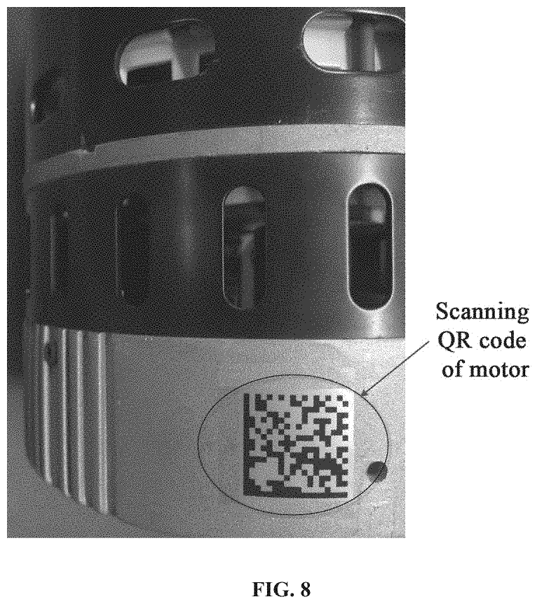

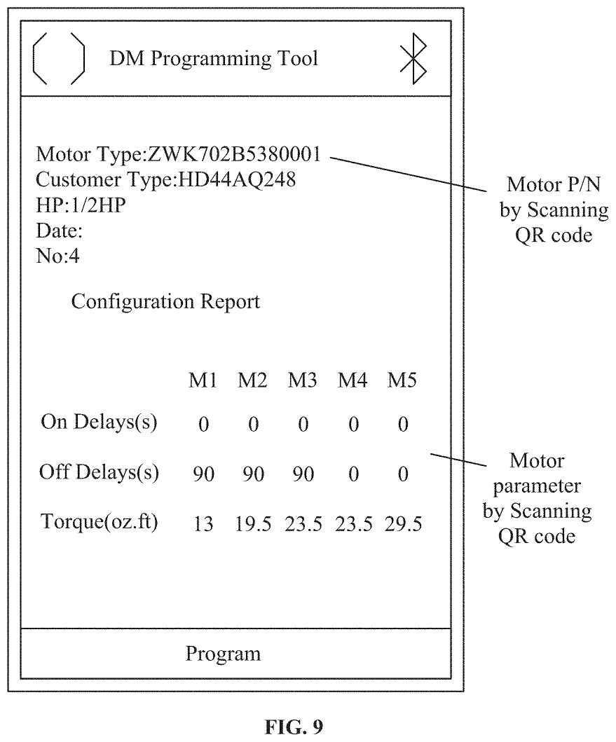

3) clicking the icon corresponding to the scanning module on the operation interface, and scanning the QR code or barcode (FIG. 8 shows the QR code on the nameplate of a new motor) on the nameplate of an old motor via the mobile phone, and the APP software module automatically loads the motor operating parameters on the operation interface, as shown in FIG. 9;

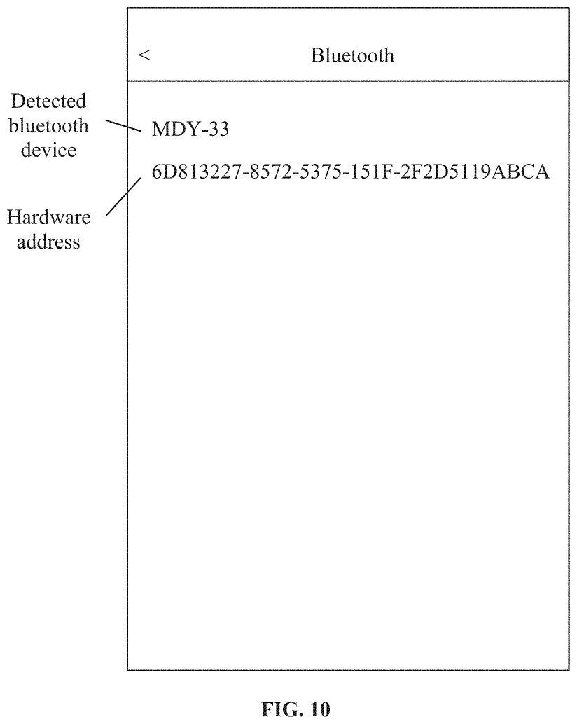

4) clicking the Bluetooth icon on the operation interface, selecting the corresponding Bluetooth communication device, establishing a wireless connection between the mobile phone and the Bluetooth communication device, as shown in FIG. 10;

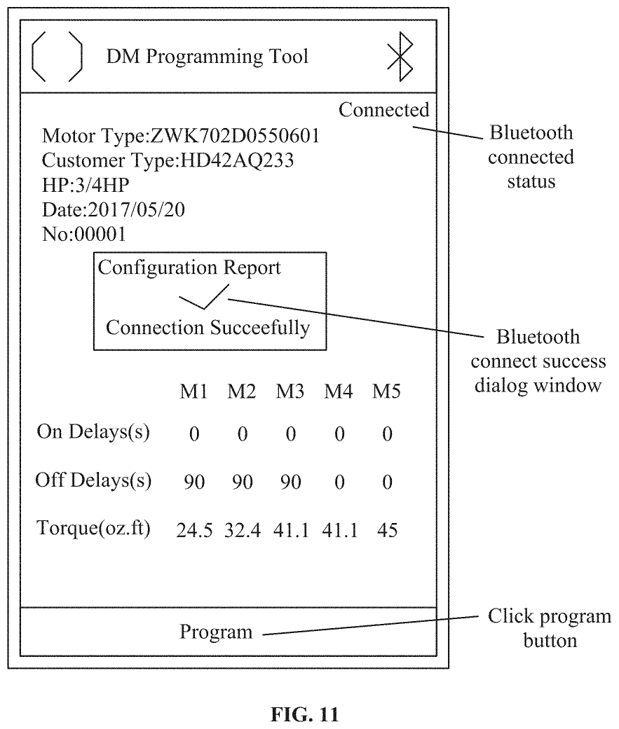

5) displaying, by the APP software module of the mobile phone, a successful connection between the mobile phone and the Bluetooth communication device, as shown in FIGS. 11; and

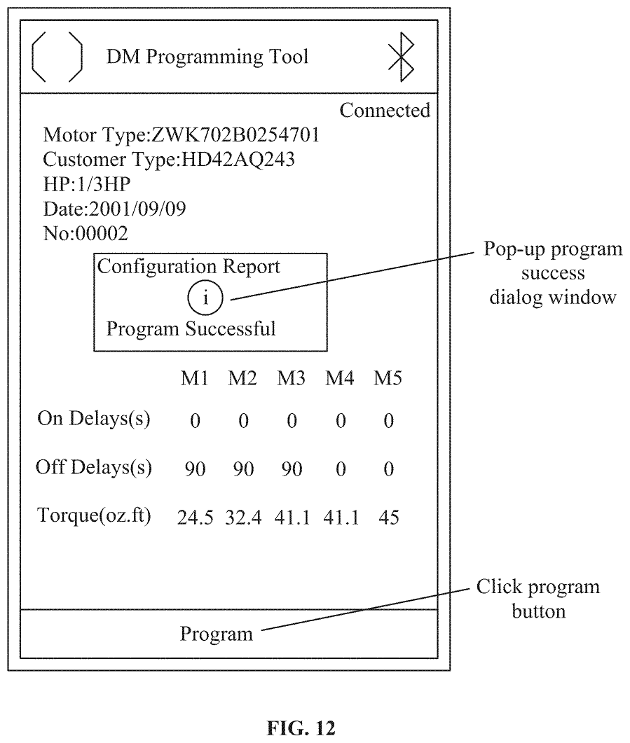

6) programing the record of the first motor comprising the motor model, user type, and corresponding operating parameters presented on the operation interface of the mobile phone to yield the program, and transmitting the program to the motor controller of the new motor, as shown in FIG. 12.

The motor programming device of the disclosure comprises a mobile phone and a Bluetooth communication device which are wirelessly connected, program and transmit the relevant data of the motor controller of a first motor to the motor controller of a second motor, and no extra equipment is involved. The programming device is compact and easy to carry. The programming method is easy to operate, and is efficient in loading the operating parameters of an old or broken motor controller to a new one.

It will be obvious to those skilled in the art that changes and modifications may be made, and therefore, the aim in the appended claims is to cover all such changes and modifications.

1. A device, comprising:
1) a mobile phone, the mobile phone comprising:
1.1) a Bluetooth module;
1.2) a motor information database comprising a plurality of records of a first motor, the plurality of records of the first motor each comprising a motor model, user type, and corresponding operating parameters; and
1.3) an APP software module, which is configured to receive a piece of search information, automatically search in the motor information database a record corresponding to the search information, extract relevant data of the record, and program relevant data of the record to yield a program;)
2) a Bluetooth communication device, the Bluetooth communication device being configured to physically connect to a motor controller of a second motor and wirelessly connected to the mobile phone via the Bluetooth module, and being configured to transmit the program produced by the APP software module to the motor controller of the second motor.

2. The device of claim 1, wherein the plurality of records each comprises a quick response (QR) code field or barcode information of the first motor, and the APP software module comprises a scanning module; the scanning module is configured to scan the quick response code or barcode information of the first motor; and the search information corresponds to the QR code or barcode information of the first motor.

3. The device of claim 1, wherein the search information comprises a motor model and a user type.

4. The device of claim 1, wherein the corresponding operating parameters comprise torque data, speed data and air volume data.

5. The device of claim 4, wherein the torque data, the speed data, and the air volume data each comprise a plurality of data groups for different tap positions.

6. The device of claim 5, wherein the Bluetooth communication device communicates with the motor controller via a universal asynchronous receiver/transmitter (UART).

7. A method of programming a motor controller of a motor using the device of claim 2, the method comprising:
1) scanning a quick response (QR) code or barcode information of the first motor using the scanning module of the APP software module of the mobile phone, and generating a piece of search information corresponding to the quick response code or barcode information of the first motor;
2) automatically searching in the motor information database a record corresponding to the search information, the record comprising a motor model, user type, and corresponding operating parameters;
3) extracting relevant data of the record, and programing relevant data of the record to yield a program; and
4) transmitting, by the Bluetooth communication device, the program produced by the APP software module to the motor controller of the second motor.

8. The method of claim 7, comprising:
physically connecting the Bluetooth communication device to the motor controller of the second motor;
clicking the APP software module of the mobile phone;
scanning the quick response code or barcode information of the first motor using the scanning module of the APP software module, so that the record of the first motor comprising the motor model, user type, and corresponding operating parameters is presented on an operation interface of the mobile phone;
clicking a Bluetooth icon on the operation interface, seeking the Bluetooth communication device, and wirelessly connecting the mobile phone and the Bluetooth communication device;
displaying, by the APP software module of the mobile phone, a successful connection between the mobile phone and the Bluetooth communication device; and
programing the record of the first motor comprising the motor model, user type, and corresponding operating parameters presented on the operation interface of the mobile phone to yield the program, and transmitting the program to the motor controller of the second motor.

9. The device of claim 2, wherein the corresponding operating parameters comprise torque data, speed data and air volume data.

10. The device of claim 9, wherein the torque data, the speed data, and the air volume data each comprise a plurality of data groups for different tap positions.

11. The device of claim 10, wherein the Bluetooth communication device communicates with the motor controller via a universal asynchronous receiver/transmitter (UART).

12. The device of claim 3, wherein the corresponding operating parameters comprise torque data, speed data and air volume data.

13. The device of claim 12, wherein the torque data, the speed data, and the air volume data each comprise a plurality of data groups for different tap positions.

14. The device of claim 13, wherein the Bluetooth communication device communicates with the motor controller via a universal asynchronous receiver/transmitter (UART).
